(19) United States
(12) Patent Application Publication
(10) Pub. No.: US 2025/0151011 A1
(43) Pub. Date: May 8, 2025

(54) METHODS AND APPARATUS FOR CLUSTER-BASED POSITIONING OF WIRELESS TRANSMIT/RECEIVE UNITS IN A WIRELESS COMMUNICATION NETWORK

(71) Applicant: InterDigital Patent Holdings, Inc., Wilmington, DE (US)

(72) Inventors: Fumihiro Hasegawa, Westmount (CA); Dylan Watts, Montreal (CA); Jaya Rao, Montreal (CA); Oumer Teyeb, Montreal (CA); Moon IL Lee, Melville, NY (US); Paul Marinier, Brossard (CA); Tuong Hoang, Montreal (CA); Janet Stern-Berkowitz, Little Neck, NY (US)

(73) Assignee: InterDigital Patent Holdings, Inc., Wilmington, DE (US)

(21) Appl. No.: 18/837,249

(22) PCT Filed: Feb. 8, 2023
(86) PCT No.: PCT/US2023/012633

§ 371 Date: Aug. 9, 2024

Related U.S. Application Data
(60) Provisional application No. 63/308,212, filed on Feb. 9, 2022.
(60) Provisional application No. 63/410,484, filed on Sep. 27, 2022.

(51) Int. Cl. H04W 64/00

(52) U.S. Cl. CPC H04W 64/00

(57) ABSTRACT

Methods, apparatuses, and systems for determining and communicating positioning information in a wireless communication network are provided. For example, a method implemented by a wireless transmit/receive unit (WTRU) includes receiving information indicating a set of position reference signal (PRS) configurations and cluster information. Each PRS configuration is associated with a respective cluster and respective cluster information. The method also includes determining a first location of the WTRU using a first PRS configuration, selecting a cluster that encompasses the first location and is associated with a second PRS configuration, determining a second location of the WTRU based on the second PRS configuration, and transmitting second information indicating the second location of the WTRU and respective cluster information of the selected cluster.

### CROSS-REFERENCE TO RELATED APPLICATIONS

This application claims priority to and the benefit of U.S. Provisional Application No. 63/308,212 filed in the U.S. Patent and Trademark Office on Feb. 9, 2022, and U.S. Provisional Application No. 63/410,484 filed in the U.S. Patent and Trademark Office on Sep. 27, 2022, the entire contents of each of which being incorporated herein by reference as if fully set forth below in their entirety and for all applicable purposes.

### SUMMARY

Embodiments disclosed herein generally relate to wireless communication networks. For example, one or more embodiments disclosed herein are related to methods, apparatuses, and systems for determining and communicating cluster-based positioning information (e.g., a geographic position, a location, positioning configurations, positioning measurements, and/or a measurement report for positioning) in a wireless communication network. Various embodiments and methods may be implemented in a wireless transmit/receive unit (WTRU) in a wireless communication network (e.g., a 5G NR network).

In one embodiment, a method implemented in a wireless transmit/receive unit (WTRU) for wireless communications includes receiving information indicating a set of position reference signal (PRS) configurations and cluster information. Each PRS configuration is associated with a respective cluster and respective cluster information. The method also includes determining a first location of the WTRU using a first PRS configuration, selecting a cluster that encompasses the first location and is associated with a second PRS configuration, determining a second location of the WTRU based on the second PRS configuration, and transmitting second information indicating the second location of the WTRU and respective cluster information of the selected cluster.

In one embodiment, a method implemented in a WTRU for wireless communications includes receiving first information indicating 1) a set of position reference signal (PRS) configurations including a first PRS configuration and a second PRS configuration and 2) cluster information of a plurality of clusters. Each PRS configuration of the set of PRS configurations is associated with a respective cluster of the plurality of clusters and respective cluster information. The method also includes determining a first location of the WTRU using the first PRS configuration; selecting, from the plurality of clusters and based on the first location and the cluster information of the plurality of clusters, a cluster that encompasses the first location and is associated with the second PRS configuration; determining, based on the second PRS configuration associated with the selected cluster, a second location of the WTRU; and transmitting second information indicating 1) the second location of the WTRU and 2) respective cluster information of the selected cluster.

In another embodiment, a method implemented in a WTRU for wireless communications includes receiving an initial PRS configuration from a network; measuring PRS in accordance with the initial PRS configuration; transmitting a position of the WTRU to the network based on the measured PRS with the initial configuration; receiving, from the network, cluster information defining clusters of WTRUs in the network; receiving, from the network, cluster PRS configuration information defining PRS configurations associated with the clusters. The method also includes determining at least one cluster to which the WTRU belongs based on the cluster information; determining a second PRS configuration for the WTRU based on the cluster PRS configuration information; measuring PRS in accordance with the second PRS configuration; and transmitting a position of the WTRU to the network determined based on the measured PRS with the second PRS configuration.

### BRIEF DESCRIPTION OF THE DRAWINGS

A more detailed understanding may be had from the detailed description below, given by way of example in conjunction with the drawings appended hereto. Figures in such drawings, like the detailed description, are exemplary. As such, the Figures and the detailed description are not to be considered limiting, and other equally effective examples are possible and likely. Furthermore, like reference numerals (“ref.”) in the Figures (“FIGs.”) indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a diagram illustrating the concept of WTRU clusters for purposes of positioning in a wireless network in accordance with an embodiment;

FIG. 3 is a diagram illustrating a process of a WTRU determining a cluster with which it is associated in accordance with an embodiment;

FIG. 4 is a diagram illustrating a process of a WTRU determining a plurality of clusters with which it is associated in accordance with an embodiment;

FIG. 5 is a diagram illustrating a process of a WTRU selecting a cluster to use for PRS configuration from multiple clusters with which it is associated based on relative cluster sizes in accordance with an embodiment;

FIG. 6 is a signal flow diagram illustrating a process in accordance with an exemplary embodiment;

FIG. 7 is a diagram illustrating a process of a WTRU determining a cluster with which it is associated in accordance with a WTRU-assisted embodiment;

FIG. 8 is a diagram illustrating a process of a WTRU determining a plurality of clusters with which it is associated in accordance with a WTRU-assisted embodiment;

FIG. 9 is a diagram illustrating a process of a WTRU selecting a cluster to use for PRS configuration from multiple clusters with which it is associated based on relative cluster sizes in accordance with a WTRU-assisted embodiment;

FIG. 10 is a timing diagram illustrating an exemplary measurement gap configuration in accordance with an embodiment;

FIG. 11 is a diagram illustrating a hierarchy for measurement gap configuration in accordance with an embodiment;

FIG. 12 is a diagram illustrating a hierarchy for PRS parameters in accordance with an embodiment;

FIG. 13 is a diagram illustrating differential cluster-based positioning of a WTRU according to some embodiments;

FIG. 14 is a diagram illustrating cluster-based positioning of a WTRU using non-differential reporting of location information in accordance with an embodiment;

FIG. 15 is a diagram illustrating cluster-based positioning of a WTRU wherein the WTRU determines a cluster with which it is associated in accordance with an embodiment;

FIG. 16 is a diagram illustrating cluster-based positioning of a WTRU wherein the WTRU has determined a cluster with which it is associated and determines its location based on configuration information associated with the determined cluster in accordance with an embodiment; and

FIG. 17 is a diagram illustrating an exemplary relationship between clusters in a non-terrestrial network in accordance with an embodiment.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components, and circuits have not been described in detail, so as not to obscure the following description. Further, embodiments and examples not specifically described herein may be practiced in lieu of, or in combination with, the embodiments and other examples described, disclosed, or otherwise provided explicitly, implicitly and/or inherently (collectively “provided”) herein.

### 1 Example Communication Systems

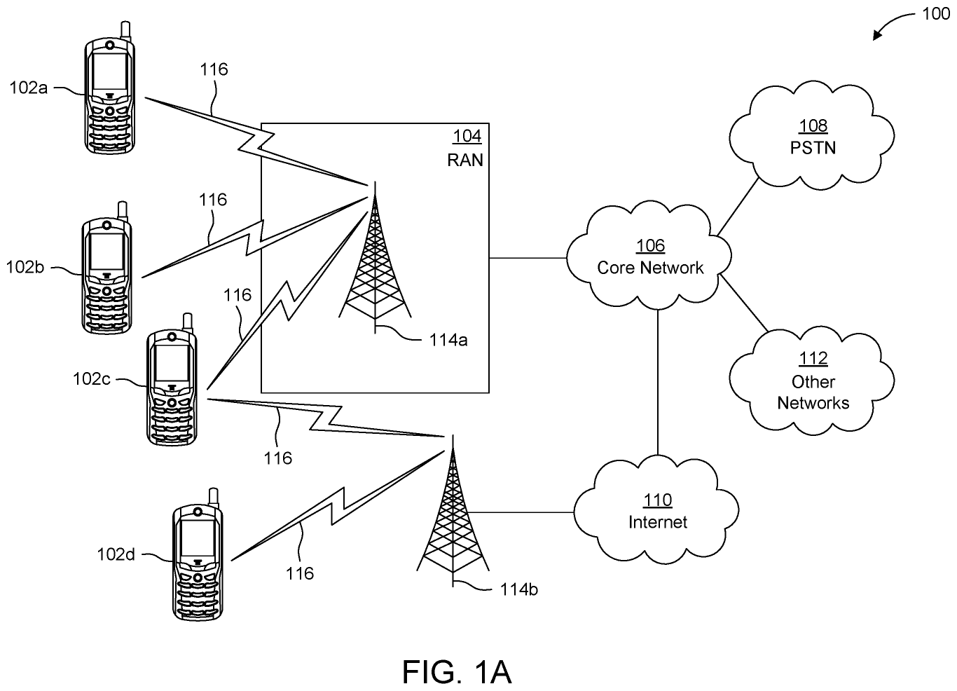

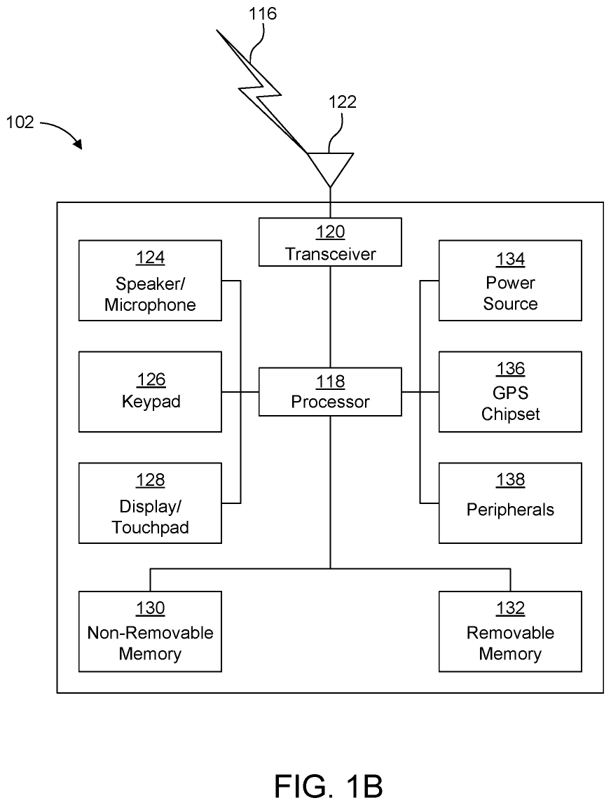

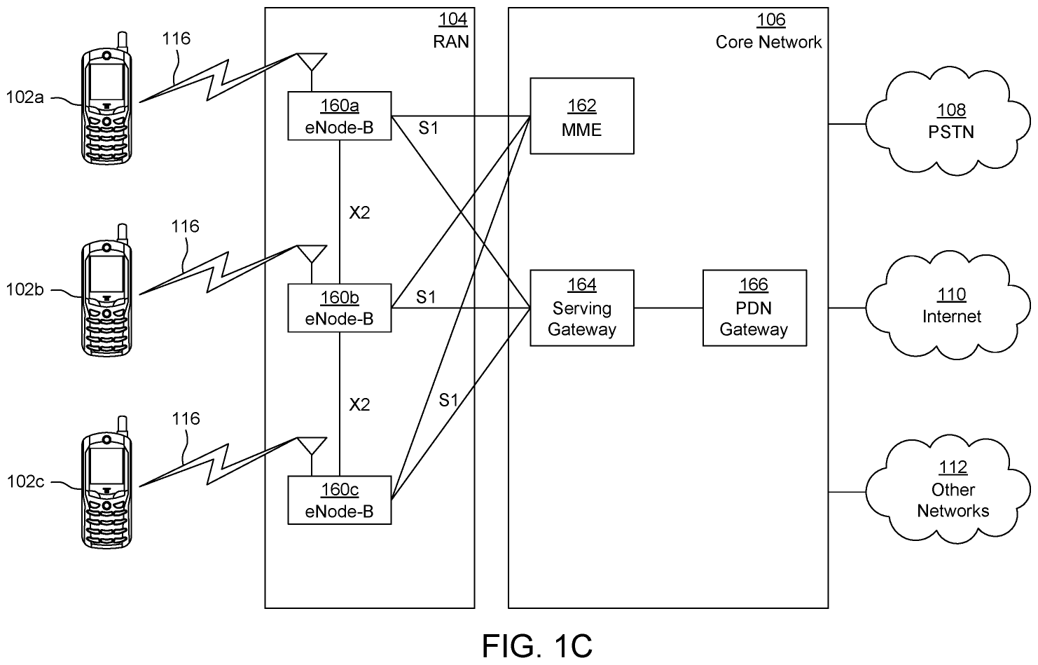

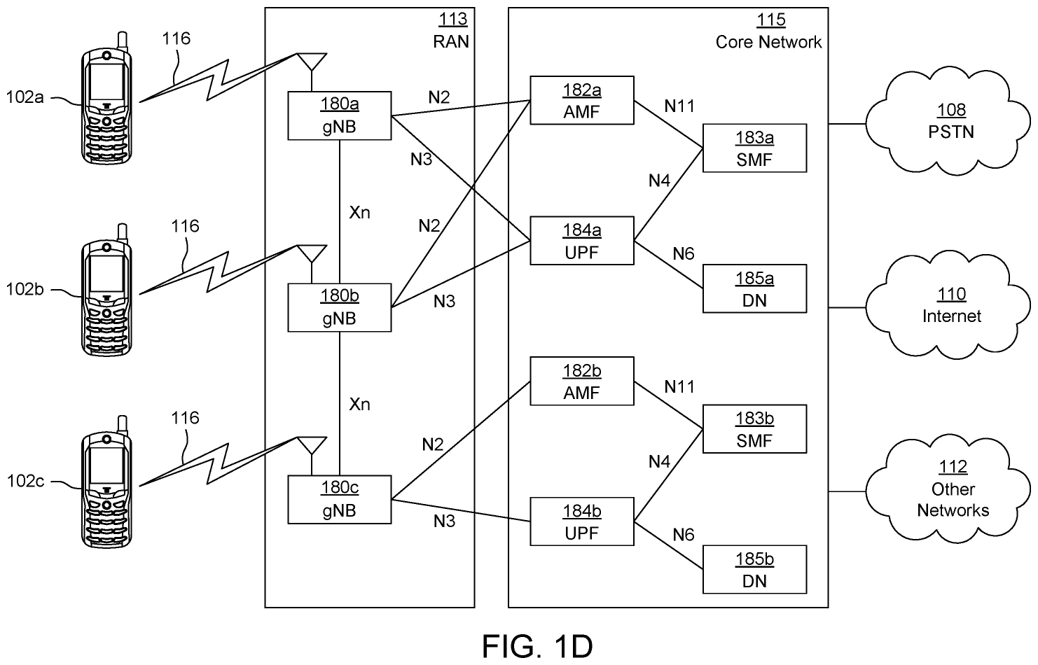

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 180b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the uplink (UL) and/or downlink (DL), support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different Packet Data Unit (PDU) sessions with different requirements), selecting a particular SMF 183a, 183b, management of the registration area, termination of Non-Access Stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF a82a, 182b may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### 2 Positioning in 3GPP Communication Systems

In 3GPP Rel. 16, downlink, uplink, and downlink and uplink positioning methods are used.

A downlink (DL) positioning method may refer to any positioning method that uses downlink reference signals, such as Positioning Reference Signals (PRS). In DL positioning methods, the WTRU receives multiple reference signals from one or more Transmission Points (TPs) and measures DL Reference Signal Time Difference (RSTD) and/or Reference Signal Received Power (RSRP). Examples of DL positioning methods include DL-AoD (Angle of Departure) and DL-TDOA (Time Difference of Arrival) positioning.

An uplink or (UL) positioning method may refer to any positioning method that uses uplink reference signals such as Sounding Reference Signal (SRS) for positioning. In UL positioning methods, the WTRU transmits SRS to multiple Reception Points (RPs), and the RPs measure the UL Relative Time of Arrival (RTOA) and/or Reference Signal Received Power (RSRP). Examples of UL positioning methods are UL-TDOA (Time Difference of Arrival) or UL-AoA (Angle of Arrival) positioning.

A “DL & UL positioning method” may refer to any positioning method that uses both uplink and downlink reference signals for positioning. In one example, a WTRU may transmit SRS to multiple Transmission/Reception Points (TRPs) and a gNB measures the Rx-Tx time difference. The gNB can measure RSRP for the received SRS. The WTRU measures the Rx-Tx time difference for PRS transmitted from multiple TRPs. The WTRU can measure RSRP for the received PRS. The Rx-TX difference and possibly RSRP measured at the WTRU and the gNB may be used to compute round trip time. Herein, the term Rx-Tx difference refers to the difference between arrival time of the reference signal transmitted by the TRP and transmission time of the reference signal transmitted from the WTRU. An example of DL & UL positioning method is multi-RTT (Round Trip Time) positioning.

Significant overhead is required to support positioning in the network. Particularly, for instance, PRS configuration may be optimized for each WTRU, thereby increasing signaling overhead when there are many WTRUs. In addition, transmission of location information (e.g., position) to WTRUs requires large overhead, leading to increased latency in the network. The WTRU needs to acquire an optimum PRS configuration on-demand, which may increase latency during positioning. For the initial access procedure of NTN (non-terrestrial network) communication, position information may be needed to expedite the initial access procedure.

### 3 Terminology

In embodiments described herein, the term “network” may be inclusive of any of Access and Mobility Management Function (AMF), Location Management Function (LMF), gNB, or NG-RAN.

The terms “pre-configuration” and “configuration” may be used interchangeably in this disclosure.

The terms “non-serving gNB” and “neighboring gNB” may be used interchangeably in this disclosure.

The terms “gNB” and “TRP” may be used interchangeably in this disclosure.

The terms “PRS” or “PRS resource” may be used interchangeably in this disclosure.

The terms “PRS(s)” or “PRS resource(s)” may be used interchangeably in this disclosure. The aforementioned “PRS(s)” or “PRS resource(s)” may belong to different PRS resource sets.

The terms “PRS” or “DL-PRS” or “DL PRS” may be used interchangeably in this disclosure.

The terms “measurement gap” or “measurement gap pattern” may be used interchangeably in this disclosure. “Measurement gap pattern” may include parameters such as measurement gap duration, measurement gap repetition period, and measurement gap periodicity.

A Positioning Reference Unit (PRU) may be a WTRU or TRP whose location (e.g., altitude, latitude, geographic coordinate, or local coordinate) is known by the network (e.g., gNB, LMF). Capabilities of PRUs may be the same as a WTRU or TRP, e.g., capable of receiving PRS or transmitting SRS or SRS for positioning, return measurements, or transmitting PRS. The WTRUs acting as PRUs may be used by the network for calibration purposes (e.g., correct unknown timing offset, correct unknown angle offset).

An LMF is a non-limiting example of a node or entity (e.g., network node or entity) that may be used for or to support positioning. Any other node or entity may be substituted for LMF and still be consistent with this disclosure.

### 4 Reduction of Overhead Signaling for Positioning

### 4.1 WTRU-Based Cluster Positioning

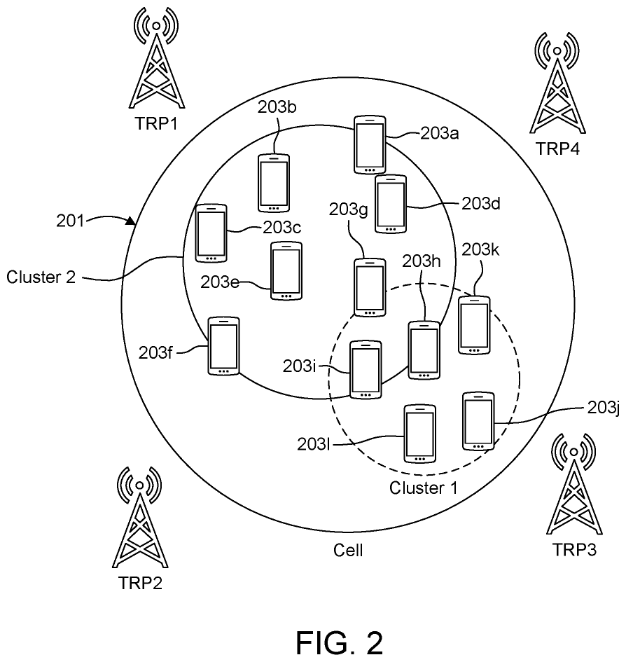

In one embodiment, the WTRU may receive PRS configurations associated with one or more clusters of WTRUs. FIG. 2 helps illustrate the concept of clusters. In the diagram, the network forms clusters in a cell depending on the location of WTRUs and density of the WTRUs in a cell. The WTRUs in a cell are grouped into multiple clusters, wherein some WTRUs may be associated with more than one cluster and wherein other WTRUs in a cell may not belong to any clusters.

In the example shown in FIG. 2, the cell 201 comprises two clusters of WTRUs 203, cluster 1 and cluster 2. Three of the WTRUs, namely, 203g, 203h, and 203i belong to both clusters. WTRUs 203a-203f belong only to cluster 2, while WTRUs 203j-203l belong only to cluster 1.

In one example, the size and location of clusters may vary depending on the locations of the WTRUs. PRS configurations may be associated with each cluster. One PRS configuration may be associated with multiple clusters. Once the WTRU determines the cluster(s) with which it is associated, the WTRU may determine which PRS configuration it should use.

In one example, for WTRU-based positioning, the WTRU may receive the initial PRS configuration from the network (e.g., gNB, LMF). The WTRU may receive the initial PRS configuration prior or after the WTRU initiates cluster-based positioning. The WTRU may receive the initial PRS configuration in an LTE Positioning Protocol (LPP) message or broadcast. The WTRU may receive the initial PRS configuration if the configuration is dedicated for the WTRU (e.g., in a dedicated manner). The WTRU may receive the initial PRS configuration in a broadcast message.

In one embodiment, the PRS configurations for the different clusters may be independent from each other.

In another embodiment, the PRS configurations for different clusters may be related. For example, WTRUs may be configured with an initial PRS configuration, and the PRS configuration associated with the different clusters may just indicate what is to be added or/and subtracted from the initial configuration. As another example, there may be a (default) cluster which all (or most WTRUs) belong to, and the PRS configuration of any additional clusters to which a certain WTRU belongs may be indicated as an addition or subtraction from the default cluster's configuration.

In one embodiment, when a WTRU belongs to multiple clusters, it will use all the PRSs configured in all the clusters (i.e., a union of the PRSs).

In another embodiment, when a WTRU belongs to multiple clusters, it will use only the parts of the various PRS configurations that each PRS configuration has in common with the others (i.e., an intersection of the PRSs).

In yet another embodiment, when a WTRU belongs to multiple clusters, it will use the configuration that has the most PRSs configured.

In yet further embodiments, when a WTRU belong to multiple clusters, it will use the configuration that has the least PRSs configured.

In one embodiment, clusters may have associated with them a priority (which priority may be, e.g., included in the cluster configuration, separately indicated via explicit signaling, implicit from the cluster IDs, etc.), and a WTRU that belongs to multiple clusters may consider/measure only the PRSs of the highest priority cluster (or the top n priority clusters). The WTRU may request a measurement gap from the network (e.g., LMF, gNB) if the WTRU needs a measurement gap to make the measurements on PRS and/or process the measurements. The WTRU may request a measurement gap if the PRS is received outside of the active Bandwidth Part (BWP) or the WTRU is not capable of processing data and measurement results simultaneously.

After the WTRU receives a measurement gap configuration (e.g., measurement gap duration, periodicity, offset), the WTRU may perform measurements on the received PRS.

Based on the configuration, the WTRU may make measurements on the configured PRS resources. Based on the measurements, the WTRU may return the initial location information (e.g., the WTRU's position) to the network.

In one embodiment, a WTRU that belongs to multiple clusters may use the configured/available measurement gap to determine which PRSs to measure. For example, if the measurement gap configured is not long enough to accommodate measuring all of the configured PRSs, the WTRU may measure only the PRSs from the top priority cluster(s).

In another embodiment, if a WTRU is not able to measure all the PRSs associated with all the clusters that it belongs to, it may rotate the performing of the measurements for the PRSs of the different clusters during different measurement gaps. For example, in the first measurement gap, the WTRU performs the measurements of the PRSs belonging to cluster1, in the next measurement gap, the WTRU performs the measurements of the PRSs of the second cluster, and so on.

In yet another embodiment, if a WTRU is not able to measure all the PRSs associated with all the clusters that it belongs to, it may send a request to the network for the measurement gap to be increased (e.g., longer gap duration, more frequent gaps, etc.).

In one embodiment, if a WTRU determines that it is configured with a measurement gap that is longer than required for performing the measurements of all the PRSs associated with the clusters that it belongs to, it may send an indication/request to the network for the measurement gap to be decreased (e.g., shorter gap, less frequent gaps, etc.).

The WTRU may initiate cluster-based positioning by requesting broadcast or dedicated information containing cluster information from the network. The WTRU may determine to initiate cluster-based positioning if the WTRU receives an indication from the network to initiate cluster-based positioning.

The WTRU may determine to initiate cluster-based positioning if the WTRU is configured to perform cluster-based positioning.

The WTRU may determine to initiate cluster-based positioning if the WTRU receives an indication from the network to initiate cluster-based positioning after the WTRU returns the first location information.

The WTRU may determine to initiate cluster-based positioning if the time remaining until the latency requirement is less than a preconfigured threshold.

The WTRU may determine to initiate cluster-based positioning if the WTRU is not configured to send an on-demand PRS request.

The WTRU may determine to initiate cluster-based positioning if the WTRU does not have a list of preconfigured PRS parameters.

The WTRU may determine to initiate cluster-based positioning if the Quality of Service (QOS) requirement (e.g., accuracy) is below a preconfigured threshold (e.g., the accuracy requirement for the WTRU is 1 meter and the preconfigured threshold is 30 cm). In other words, the accuracy requirement for the WTRU may be loose enough for cluster-based positioning.

The WTRU may determine to initiate cluster-based positioning upon expiry of a validity timer applicable to previously configured cluster information.

The WTRU may determine to initiate cluster-based positioning if at least one condition associated to at least one measurement (e.g., RRM measurement) is met.

In the examples mentioned herein, the WTRU may obtain cluster information or PRS configuration via broadcast, multicast, unicast, or WTRU-dedicated signaling. The methods to obtain cluster related information or PRS configuration are not limited to broadcast.

In one embodiment, broadcast information may be received from the network in the Physical Broadcast Channel (PBCH) and/or Physical Downlink Shared Channel (PDSCH). The broadcast information may be contained in the System Information Block (SIB), Radio Resource Control (RRC), LPP messages, a Media Access Control-Control Element (MAC-CE), or Downlink Control Information (DCI). After the WTRU's request for the cluster information is granted, the WTRU may receive broadcast information from the network, which may contain any one or more of: ID (identification) number associated with a cluster; location (e.g., center or centroid) of a cluster, shape of a cluster (e.g., circle, ellipse, square, rectangle; size of a cluster (e.g., radius, diameter, length of semi-minor/major axis, diagonal length, circumference); density of a cluster (e.g., number of WTRUs in the cluster); at least one applicable time window (e.g., from 8:00 to 23:00); and/or a validity time or timer.

In another example, the WTRU may receive the above information in a dedicated message. The WTRU may receive the message, e.g., via RRC, LPP message, PDSCH, MAC-CE, or DCI.

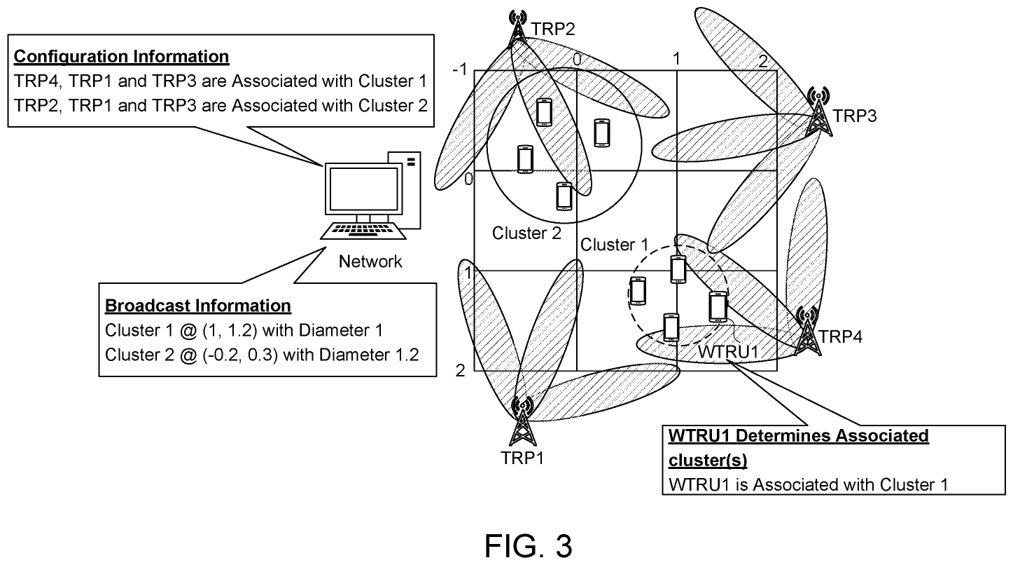

Based on the initial location information, the WTRU may determine the cluster the WTRU is associated with. An example is illustrated in FIG. 3, wherein WTRU1 determines to associate itself with cluster1 based on the broadcast information from the network that cluster1 is centered at coordinate 1, 1,2 and has a diameter of 1 in combination with its knowledge of the WTRU's position being within that area. Similarly, WTRU determines that it is not within cluster2 based on that cluster's center and diameter information as compared to the WTRU's location. In the figure, there are 4 TRPs, with PRS transmitted from each TRP and cluster1 is configured to use PRS from TRPs 1, 3, and 4.

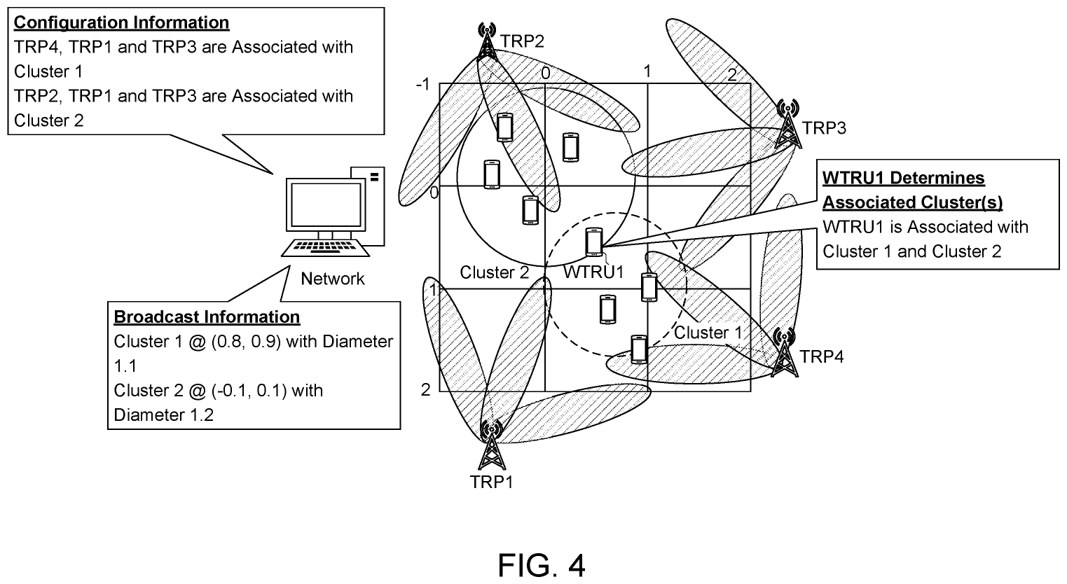

In another example illustrated by FIG. 4, WTRU1 may determine to associate itself with more than one cluster. Particularly, in the example shown in FIG. 4, WTRU1 is within the area covered by both cluster1 and cluster2. Thus, based on broadcast information from the network, the WTRU determines to associate itself with both cluster 1 and cluster 2.

Based on the WTRU's request for broadcast information containing cluster information, the WTRU may also receive broadcast information containing association information between PRS configuration and clusters. The WTRU may send a separate request to the network to broadcast information which contain association information between PRS configuration and clusters. The aforementioned association information may comprise at least one PRS configuration set ID and cluster ID, where the WTRU may be preconfigured with PRS configuration sets.

The aforementioned association information may comprise one or more PRS configuration parameters (e.g., PRS resource ID, PRS resource set ID, number of PRS symbols) and cluster ID.

In one embodiment, a PRS configuration may contain at least one of the following parameters: number of symbols, transmission power, number of PRS resources included in PRS resource set, muting pattern for PRS (for example, the muting pattern may be expressed via a bitmap), periodicity, type of PRS (e.g., periodic, semi-persistent, or aperiodic), slot offset for periodic transmission for PRS, vertical shift of PRS pattern in the frequency domain, time gap during repetition, repetition factor, RE (resource element) offset, comb pattern, comb size, spatial relation, QCL information (e.g., QCL target, QCL source) for PRS, number of PRUs, number of TRPs, Absolute Radio-Frequency Channel Number (ARFCN), subcarrier spacing, expected RSTD, uncertainty in expected RSTD, start Physical Resource Block (PRB), bandwidth, BWP ID, number of frequency layers, start/end time for PRS transmission, on/off indicator for PRS, TRP ID, PRS ID, cell ID, global cell ID, PRU ID, and applicable time window. The WTRU may apply a PRS configuration under a condition that the current time is within the applicable time window.

In one embodiment, the WTRU may receive a first (or initial) PRS configuration from the network. With the first PRS configuration, the WTRU may make measurements on the received PRS, and, based on those measurements, the WTRU may determine its position. The WTRU then may determine which cluster the WTRU is associated with based on that determined position. Thereafter, based on the cluster that the WTRU is associated with, the WTRU may determine the second PRS configuration, which is determined based on the association information between clusters and PRS configurations. The WTRU may make measurements on PRS resources under the second PRS configuration. The WTRU may determine the location information based on the measurements and report the location information to the network. The WTRU may request cluster information and/or association information between cluster and PRS configuration from the network.

As noted above, a WTRU may be associated with more than one cluster. In that case, the WTRU may determine which one (or more) of those clusters to base its PRS configuration on as a function of a preconfigured condition. The condition may be at least one of the smallest size (e.g., smallest diameter), the largest size (e.g., largest diameter), the least dense cluster, and/or the densest cluster.

In embodiments, the WTRU may determine which cluster to select based on the geographic size of the clusters with which it is associated being below/above a threshold. For example, if cluster A has a 10 m diameter and cluster B has a 20 m diameter, and the threshold is below 5 m, the WTRU does not choose a cluster. As a result, WTRU falls back to the default positioning procedure.

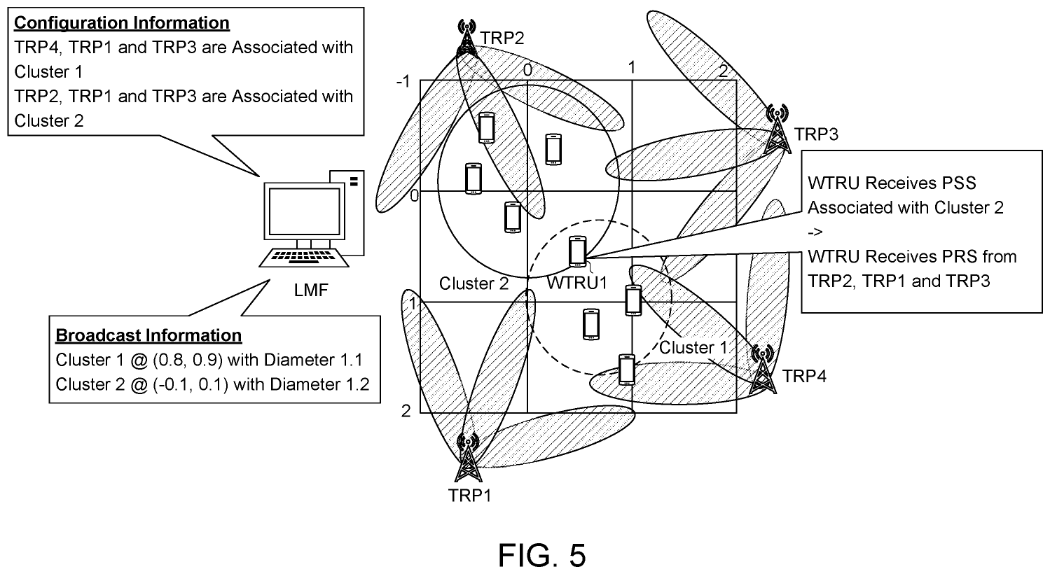

An example is illustrated in FIG. 5, where the WTRU determines that it is associated with cluster 1 and cluster 2, and the WTRU determine to receive PRS based on the PRS configuration linked with cluster 2 because, in this case, the WTRU is preconfigured to select the PRS configuration of the largest cluster with which it is associated (e.g., the WTRU receives PRS from TRP1, TRP2 and TRP3 because that is the PRS configuration of cluster 2, and cluster 2 is the largest cluster with which the WTRU is associated).

The cluster with the smallest size may be associated with higher accuracy for positioning. Thus, in other embodiments, the WTRU may determine to select the cluster with the smallest size and use the associated PRS configuration for positioning.

In one embodiment, the WTRU may measure RSRP or quality of measurements of PRS from all clusters that the WTRU is associated with and select a cluster for PRS configuration based on the measurements. For example, the WTRU may be configured to select the cluster based on cluster with the highest average RSRP.

For example, the WTRU may be configured to select the cluster based on cluster with the lowest average RSRP.

For example, the WTRU may be configured to select the cluster based on cluster with RSRP values between specified/configured ranges.

For example, the WTRU may be configured to select the cluster based on cluster with the highest quality of measurements (e.g., standard deviation of the average RSRP is the smallest).

For example, the WTRU may be configured to select the cluster based on cluster with the lowest quality of measurements (e.g., standard deviation of the average RSRP is the smallest).

The WTRU may be configured to select the cluster based on any combination of the aforementioned factors.

In another embodiment, the WTRU may not be associated with any clusters. In such a case, the WTRU may continue to use the current PRS configuration. The WTRU may determine to use the fall-back positioning procedure where the WTRU may receive a specific PRS configuration from the network or the WTRU may obtain a new PRS configuration based on the on-demand request from the WTRU for a specific or sets of PRS configurations.

### WTRU Requests PRS Configuration Based on Indicated Cluster ID

In another example, the WTRU may determine to request, from the network, PRS configuration associated with an indicated cluster. The WTRU may make the request after the WTRU determines the cluster(s) the WTRU is associated with. The WTRU may include the cluster ID in the request. In response, the WTRU may receive PRS configuration that is associated with the indicated cluster.

In certain cases, the network may override the WTRU request and may send the WTRU a PRS configuration that is not associated with the indicated cluster ID.

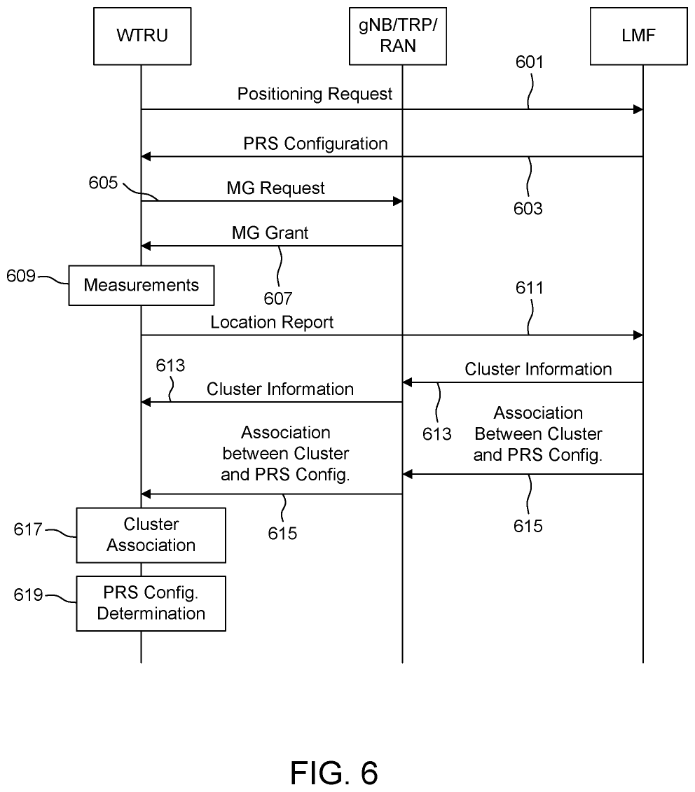

In one embodiment, FIG. 6 is a signal flow diagram illustrating an exemplary process.

At 601, the WTRU initiates cluster positioning by requesting posSIB cluster from the LMF.

At 603, the LMF transmits an initial PRS to the WTRU.

At 605, the WTRU transmits a request for a measurement gap, if needed, to the gNB.

At 607, the gNB transmits a configuration for a measurement gap, if requested in the previous step.

At 609, the WTRU makes measurements on the PRS.

At 611, the WTRU transmits its location information to the network.

At 613, the WTRU receives broadcast information containing cluster information (location, size) from the network (e.g., gNB, LMF).

At 615, the WTRU receives broadcast information associating cluster and PRS configuration from the network (e.g., gNB, LMF).

At 617, the WTRU determines the associated cluster(s) based on the broadcast information and WTRU location.

At 619, the WTRU determines PRS configuration based on the associated cluster. If the WTRU is associated with multiple clusters, the WTRU determines the PRS configuration based on a criterion (e.g., choose PRS config associated with a smaller cluster size). If the WTRU is not associated with a cluster, the WTRU continues to use the current PRS config.

At this point, the process may return to step 605 to request a new measurement gap.

### Initial PRS Configuration

The WTRU may receive the initial PRS configuration from the network to determine its location. Based on the determined location, the WTRU determines the cluster and corresponding PRS configuration that the WTRU uses for subsequent positioning. In one example, the initial PRS configuration may contain PRS configuration(s) associated with cluster(s). For example, PRS configuration associated with a cluster may be a subset of the initial PRS configuration. For instance, using the example illustrated in FIG. 3, the initial PRS configuration may contain information related to TRPs (e.g., location of TRP1, TRP2, TRP3 and TRP4). The PRS configuration associated with cluster 1 may contain information related to TRP1 and TRP4.

In another example, PRS configuration associated with a cluster may contain additional information compared to the initial PRS configuration. For example, PRS configuration associated with a cluster may contain additional spatial information (e.g., direction of each beam, beam shape) for each PRS resource, additional PRS resources (e.g., PRS beam), and/or additional frequency layers compared to the initial PRS configuration.

In one example, a beam shape may be expressed by indicating power difference of a PRS resource compared to a reference point at indicated angles. For instance, a beam shape can be indicated by using two vectors, [−60, −30, 0, 30, 60] and [−5, −3, 0, 3, 5] where the first 5-element vector indicates angles expressed in degrees where “0” is the reference angle, and the second 5-element vector indicates power difference expressed in dBs for each respective angle represented in the first 5-element vector. The WTRU may, for example, receive the aforementioned information from the network (e.g., LMF, gNB) in the assistance data sent in an LPP message or via RRC.

The additional information compared to the initial PRS configuration may be needed to enhance positioning accuracy for cluster-based positioning. Additional information may correspond to any PRS configuration, wherein, this disclosure, PRS and SRS or SRSp (SRS for positioning) may be used interchangeably.

For example, a PRS configuration may include at least one of: PRS resource ID; PRS sequence ID (or other IDs used to generate PRS sequence); PRS resource element offset; PRS resource slot offset; PRS symbol offset; PRS QCL information; PRS resource set ID; a list of PRS resources in the resource set; the number of PRS symbols; the muting pattern for PRS; muting parameters such as repetition factor; muting options; PRS resource power; periodicity of PRS transmission; spatial direction information of PRS transmission (e.g., beam information, angles of transmission); spatial direction information of UL RS reception (e.g., beam ID used to receive UL RS, angle of arrival); frequency layer ID; TRP ID; and/or PRS ID.

In the disclosure, “TRP” may be used interchangeably with “satellite”. For example, the WTRU may receive a satellite ID, a trajectory of satellite, or mobility information of a satellite (e.g., velocity, altitude) from the network. In one example, the WTRU may receive PRS from one or more satellites, wherein PRS configurations the WTRU received may be related to satellite(s) indicated in the assistance data.

SRSp or SRS configuration may include at least one of: resource ID; comb offset values, cyclic shift values; start position in the frequency domain; number of SRSp symbols; shift in the frequency domain for SRSp; frequency hopping pattern; type of SRSp (e.g., aperiodic, semi-persistent or periodic); sequence ID used to generate SRSp, or other IDs used to generate SRSp sequence; spatial relation information, indicating which reference signal (e.g., DL RS, UL RS, CSI-RS, SRS, DM-RS) or SSB (e.g., SSB ID, cell ID of the SSB) the SRSp is related to spatially; QCL information (e.g., a QCL relationship between SRSp and other reference signals or SSB); QCL type (e.g., QCL type A, QCL type B, QCL type D); resource set ID; list of SRSp resources in the resource set; transmission power related information; pathloss reference information which may contain index for SSB, CSI-RS or PRS; periodicity of SRSp transmission; and/or spatial information such as spatial direction information of SRSp transmission (e.g., beam information, angles of transmission), spatial direction information of DL RS reception (e.g., beam ID used to receive DL RS, angle of arrival)

### Reporting

In one example, if the initial WTRU location encompasses more than one cluster, the WTRU may determine which cluster the WTRU will associate itself with and use the corresponding PRS configuration to re-determine the WTRU location. The WTRU may report to the network the second WTRU location along with the PRS configuration that the WTRU used to determine the second WTRU location. In addition, the WTRU may report the cluster ID(s) that the WTRU associated itself with to determine the second WTRU location.

For example, the WTRU may include determined/estimated WTRU location in the report when the WTRU performs WTRU-based cluster-based positioning.

For example, the WTRU may include cluster ID(s) that the WTRU used to determine the PRS configuration(s) in the report when the WTRU performs WTRU-based cluster-based positioning.

For example, the WTRU may include PRS configuration (e.g., TRP ID, cell ID, resource ID, resource set ID) used to determine the WTRU location in the report when the WTRU performs WTRU-based cluster-based positioning.

For example, the WTRU may include a timestamp associated with the report in the report when the WTRU performs WTRU-based cluster-based positioning.

In one embodiment, a WTRU is configured with WTRU-based DL positioning. The WTRU receives the first PSR configuration. The WTRU receives locations and sizes of clusters (e.g., center and diameter) and associated PRS configurations (e.g., TRPs associated with each cluster) from the network. The WTRU determines its location (e.g., first location) using the first PRS configuration. Based on the first location, the WTRU determines the cluster that encompasses the first location and PRS configuration associated with that cluster (second PRS config). If the determined WTRU location is encompassed within more than one cluster, the WTRU determines the cluster with the smallest diameter. The WTRU determines its location based on the second PRS configuration and reports it to the network.

Based on the WTRU-based cluster positioning, the WTRU may obtain an optimal configuration associated with its location without sending an on-demand request to the network, thereby saving signaling overhead for both WTRU and network.

### 4.2 WTRU-Assisted Cluster Positioning

### WTRU-Assisted Cluster Positioning

In WTRU-assisted cluster positioning, the WTRU may receive the initial PRS configuration from the network. Based on the PRS configuration, the WTRU may make measurements on received PRS. The WTRU may return measurements to the network (e.g., gNB, LMF). Instead of receiving location information determined by the network, the WTRU may determine its position by associating itself with one or more clusters.

For instance, after the WTRU transmits the measurements made on PRS, the WTRU may initiate cluster-based positioning by requesting broadcast information from the network. The WTRU may receive broadcast information, which may comprise the aforementioned cluster information (e.g., location(s) of cluster(s), size(s) of cluster(s)).

The WTRU may receive PRS configurations associated with clusters from the network by broadcast. The WTRU may receive a message from the network that associates the WTRU with one or more clusters. The message may be received via LPP message, DCI, MAC-CE, or RRC. The message may contain a cluster ID. Based on the message and broadcast information, the WTRU may determine the PRS configuration it should associate itself with.

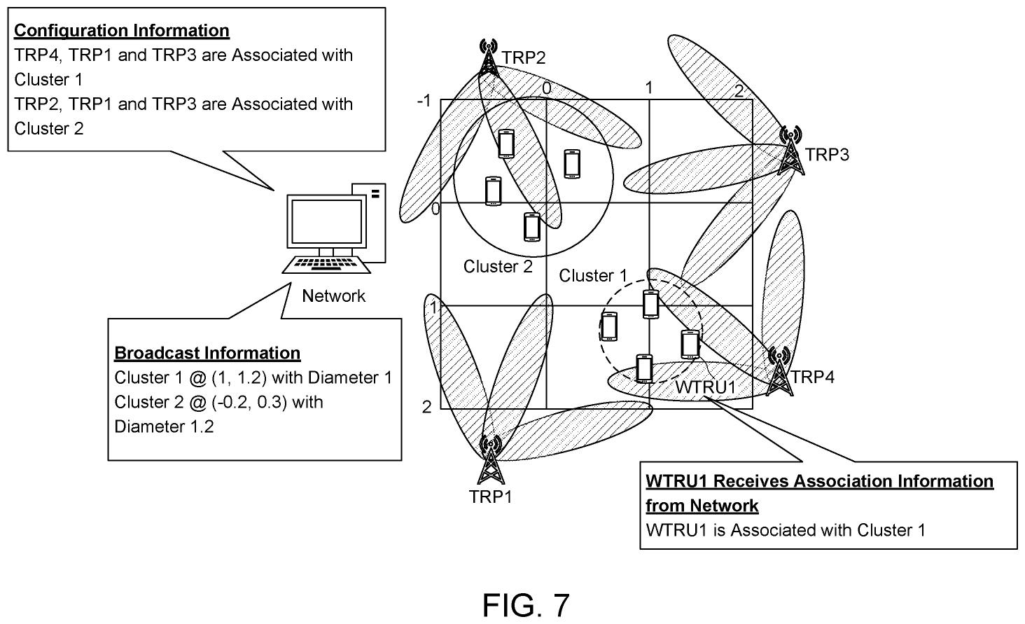

An example is illustrated in FIG. 7, where WTRU1 determines to associate itself with Cluster 1 based on a cluster location/size information received from the network. The example of FIG. 6 parallels the example illustrated in FIG. 3, but with the addition of the WTRU-assisted aspects.

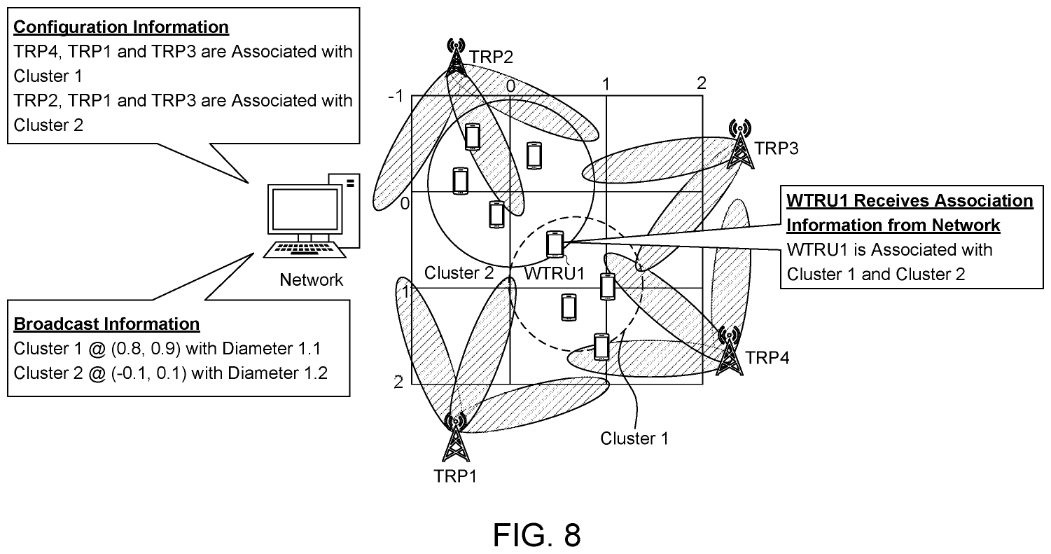

Another example is shown in FIG. 8, where WTRU1 determines to associate with multiple clusters (cluster 1 and cluster 2) based on a cluster location/size information received from the network. The example of FIG. 8 parallels the example illustrated in FIG. 4, but with the addition of the WTRU-assisted aspects.

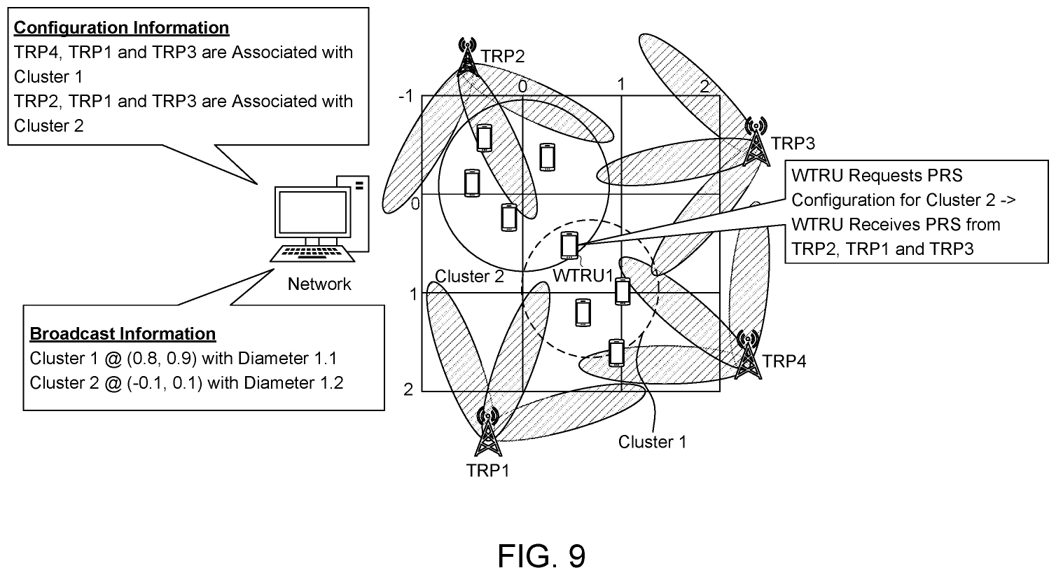

Another example is illustrated in FIG. 9, where WTRU1 determines to associate itself with cluster 2 (e.g., the diameter of cluster 2 is larger than cluster 1) and requests the network for PRS configuration associated with cluster 2. The example of FIG. 9 parallels the example illustrated in FIG. 5, but with the addition of the WTRU-assisted aspects.

In one embodiment, a WTRU may determine the PRS configuration based on the request sent from the WTRU to the network (e.g., in Step 6 below). For example,
1. The WTRU receives the initial PRS configuration (e.g., union of PRS configurations associated with clusters) and then receives PRS and returns measurements to the network.
2. The WTRU initiates cluster-based positioning by requesting broadcast information about clusters.
3. The WTRU receives periodic broadcast information of centroids and sizes of clusters, where the size of a cluster is indicated as a diameter of a circle.
4. The WTRU receives a separate message from the network, associating the WTRU with one or more cluster(s).
5. The WTRU selects a cluster based on a condition (e.g., if the WTRU is associated with multiple clusters, the WTRU chooses the cluster with the smallest/largest size)
6. The WTRU requests PRS configuration associated with the selected cluster. If the WTRU does not select a cluster, the WTRU does not send a request and uses the current PRS configuration.

7. The WTRU receives a new PRS configuration if the network grants the request.

8. Return to step 3.

### Broadcast Information

The WTRU may determine to obtain cluster information or PRS configuration via broadcast at a configured periodicity. The periodicity at which the WTRU obtains broadcast information may be configured by the network. The periodicity may be cluster-specific. For example, for relatively large clusters, the WTRU may be configured to obtain cluster information more frequently than for smaller clusters due to the likelihood of more frequent changes related to parameters of a larger cluster (e.g., size, density).

The WTRU may be configured by the network to send a request for specific parameters related to cluster or PRS configuration. Subsequently, depending on the acquired parameters or changes in the acquired parameters, the WTRU may determine to send a request to the network for PRS configuration. The request may be for delivery of PRS configuration(s) associated with the cluster(s) or for configuration of a specific PRS parameter.

For example, the WTRU may determine to send a request to the network to obtain sizes of clusters. Subsequently, the WTRU may determine to send a request for PRS configurations associated with the cluster if there has been a change exceeding a threshold (which threshold could be as low as zero) in the size of the cluster since the last time the WTRU obtained the size of the cluster.

### Inter-Cluster Mobility

The WTRU may decide to request PRS configuration(s) associated with a different cluster(s) responsive to at least mobility of the WTRU (e.g., the WTRU moves toward a different cluster. For example, if the WTRU is currently located in cluster A and moves toward cluster B, the WTRU may determine to send a request to the network for a PRS configuration associated with cluster B. While the WTRU is located in cluster A, the WTRU may receive from the network the requested cluster information (which may include information of at least cluster A and cluster B).

Alternately or additionally, the WTRU may decide to request PRS configuration(s) associated with a different cluster(s) responsive to at least interference. For example, the WTRU may detect interference caused by PRS from nearby clusters. In response, the WTRU may decide to request PRS configuration(s) and/or cluster information from cluster(s) adjacent to the cluster that the WTRU is currently operating within if interference power is above a threshold or signal to interference and noise ratio (SINR) is below the threshold.

In one example, the WTRU may send a request to the network for the network to send cluster information of clusters adjacent to the cluster that the WTRU is operating in and/or PRS configuration associated with those clusters. In another example, the WTRU may send a request to the network to send cluster information of clusters that are geographically overlapping with the cluster the WTRU is operating in and/or PRS configuration associated with those clusters.

### 4.3 WTRU Determination of its Association with Clusters Based on Static Information

### Cluster Determination

In one embodiment, the WTRU may determine which clusters to associate itself with based on zones that are configured in a cell or based on predefined, preconfigured areas. For instance, the WTRU may determine the zone the WTRU is located in, based on a location estimate (determined by the WTRU and/or received from the network). The zones may be configured by the network semi-statically. The zones may be defined by overlapping or non-overlapping partitions of a cell or by predefined areas. The WTRU may be configured by the network with a zone ID based on the WTRU's location. Based on the zone ID and cluster information (e.g., location of clusters, size of clusters), the WTRU may determine the cluster(s) with which to associate itself.

In another example, clusters may be static. The WTRU may receive cluster information from the network and they may remain static for a preconfigured duration (e.g., 10 minutes, no limit). Based on the WTRU location estimate that the WTRU obtains (e.g., via WTRU-based positioning or WTRU-assisted positioning), the WTRU may determine its association with clusters.

### 4.4 WTRU Behavior Within Clusters

### Expectation from the PRS Configuration for a Cluster

Once the WTRU determines to associate itself with a cluster and determines the PRS configuration associated with that cluster, the WTRU may align its transmission or reception parameters to receive PRS. For example, the WTRU may adjust TA (timing advance) to receive PRS from the cluster at the configured periodicity. The WTRU may request the network for a DRX (Do Not Receive) configuration so that the WTRU can align on/off timing during the DRX to receive PRS from the TRP(s).

### 4.5 Measurement Configuration for Cluster-Based Positioning

### Measurement Gap Details

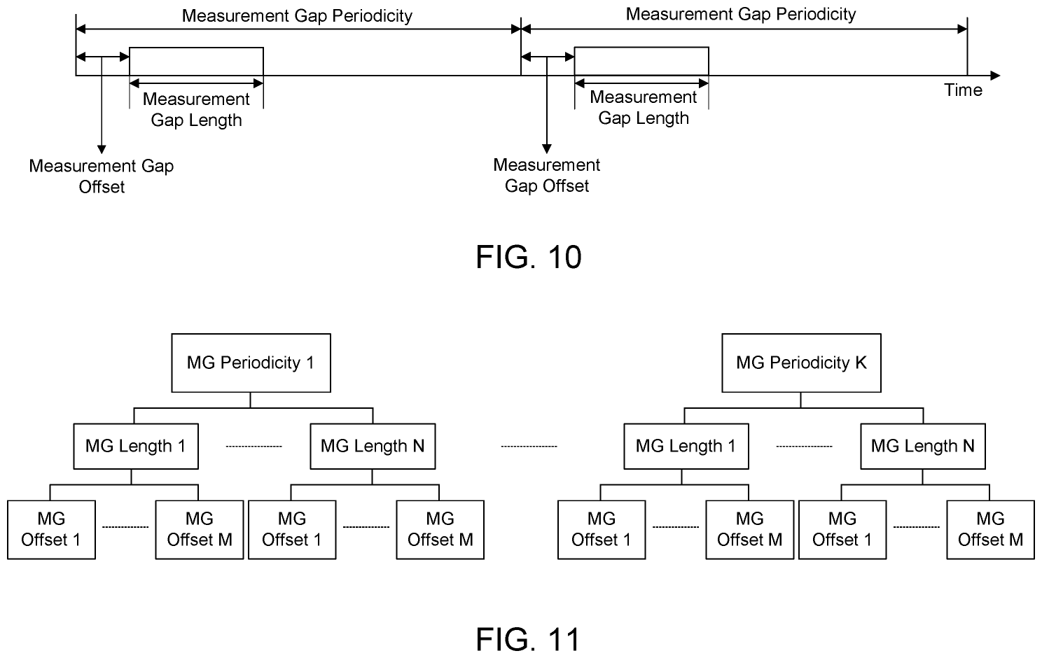

The WTRU may receive MG (measurement gap) configuration from the network via broadcast, multicast, or unicast. The WTRU may receive MG configurations or patterns from the network. Examples of an MG configuration are shown in FIG. 10, in which the WTRU does not expect to receive DL channels (e.g., PDSCH, PDCCH) during the period indicated by “Measurement gap length” in the figure. A pattern may be characterized by a periodicity, a gap length, and a gap offset, wherein each pattern may have different values of periodicity, gap length, and/or gap offset from other patterns. The WTRU may receive a list of MG patterns in broadcast information (e.g., SIB), RRC, LPP message, MAC-CE, or DCI. The WTRU may receive association information between MG patterns and clusters and/or PRS configuration in broadcast information (e.g., SIB), RRC, LPP message, MAC-CE, or DCI.

In one example, the WTRU may determine MGs associated with a cluster that the WTRU is associated with based on the aforementioned information. Based on the PRS configuration, the WTRU may request the network (e.g., gNB, LMF) to configure a MG pattern so that the WTRU can make measurements on PRS and process measurements. If there is more than one MG pattern associated with the PRS configuration and/or cluster, the WTRU may determine to send a request to the network via MAC-CE to activate one of the MG patterns. The WTRU may include in the request an ID associated with the measurement gap pattern. The WTRU may receive from the network an activation command via MAC-CE, indicating the ID of the activated measurement gap pattern. The WTRU may send a request for deactivation of the MG pattern to the network, by including the ID corresponding to the MG. In response, the WTRU may receive a deactivation command indicating the ID of the MG to be deactivated.

In one embodiment, the WTRU may receive the list of MGs from the network periodically. The period may be the same as the periodicity of the transmission of cluster information and/or PRS configuration from the network. The WTRU may receive the list of MG parameters by requesting the network for the list. The WTRU may send the request to the network via UCI, UL-MAC-CE, RRC, or LPP message.

In one example, the WTRU may receive a list of MG patterns from the network containing common parameters. For example, the WTRU may receive a list of MG parameters from the network via broadcast where the parameters may be applicable to any PRS configuration or cluster (e.g., periodicity, MG length). For parameters that are not common (e.g., MG offset), the WTRU may receive them from the network based on the PRS configuration or cluster. For example, the WTRU may receive different MG offsets depending on the cluster that the WTRU is associated with. Thus, the WTRU may determine cluster-specific or PRS-specific MG parameters once the WTRU determines the associated PRS parameter or cluster.

In another example, the MG parameters may be organized in a hierarchical structure. Each level in the hierarchy may be associated with a cluster or PRS configuration. An example of the hierarchy is shown in FIG. 11. For example, the WTRU may determine that the MG periodicity is the common parameter and the WTRU may obtain a list of values for MG periodicity from the network. Once the WTRU determines the associated cluster and/or PRS configuration, the WTRU may determine MG periodicity first that allows the WTRU to make measurements on the configured PRS. The WTRU may determine to send a request to the network for MG length and MG offset that is associated with the determined periodicity. The WTRU may receive a MG configuration from the network that is associated with the cluster or available for the cluster.

In the request for MG-related parameters described above, the WTRU may include PRS configuration ID (e.g., PRS resource ID, PRS resource set ID, TRP ID) or cluster ID to indicate whether the request is related to the cluster or PRS configuration the WTRU is associated with.

### Prioritization Window

In another embodiment, the WTRU may receive configuration related to prioritization windows for clusters. For example, the WTRU may receive a configuration for a time window during which PRS is assigned with a priority level. The configuration for the time window (e.g., duration of the timing window, start/end time) may be uniquely configured per cluster. The WTRU may receive the configuration for the time domain window via broadcast or in a dedicated message. The WTRU may determine to send a request to the network to obtain configuration for the time window once the WTRU determines which cluster the WTRU should be associated with.

The WTRU may determine priority level of the PRS during the time window based on information broadcast by the network or received via a dedicated message. The priority level of PRS may change depending on cluster information (e.g., size, density). In the request, the WTRU may include cluster information (e.g., ID of the cluster the WTRU is associated with). Once the WTRU obtains information related to PRS priority level or time window configurations, the WTRU may determine to send a request to the network via UCI, MAC-CE, RRC, or LPP message, to activate the time window. The WTRU may receive an activation command for the time window via DCI, MAC-CE, RRC, or LPP message. The WTRU may send a request to the network to deactivate the time window. The WTRU may receive a deactivation command from the network for the time window. The activation/deactivation command may contain the ID of the time window that is being activated or deactivated.

Once the prioritization of PRS is configured during the time window, the WTRU may determine to drop PRS or other DL channels (e.g., PDCCH, PDSCH) if PRS and other channels overlap in the time domain, depending on the priority level of PRS. For example, if the priority level of the PRS is higher than PDSCH and they overlap in the time domain, the WTRU may determine to drop symbols that contain PDSCH and, instead, receive and process PRS. If the prioritization time window is associated with high priority (e.g., higher than other channels), the WTRU may determine to drop DL channels that are within the window even if they do not overlap with PRS in the time domain. In another example, the WTRU may determine to receive both PRS and DL channels within the window if they do not overlap with other channels.

### 4.6 Cluster-Based Positioning for NTN

### Cluster-Based Positioning in Non-Terrestrial Networks

Cluster-based positioning may be used in non-terrestrial networks (e.g., during initial access) to overcome possible security concerns associated with transmitting WTRU location information prior to activation of Access Stratum (AS) security. For example, the WTRU may select and report a cluster during initial access/the Random Access procedure e.g., to be used during AMF selection by the network. To overcome challenges of the non-terrestrial environment (e.g., large cell sizes spanning multiple Public Land Mobile Networks (PLMNs)), additional assistance information and/or enhanced selection/reporting procedures may be supported.

### Cluster Assistance Information

The network may provide additional assistance information for a cluster to support WTRU cluster selection and reporting. Cluster assistance information may be provided, for example, via broadcast signaling (e.g., SIB1, in an NTN-specific SIB, or a new positioning-related system information block) or in a dedicated manner (e.g., via RRC signaling or MAC CE). Upon WTRU reception of dedicated cluster assistance information, the WTRU may override any cluster assistance information acquired via broadcast signaling. Alternatively, the WTRU may apply the most recently acquired cluster assistance information (e.g., regardless of manner of signaling).

In one embodiment, upon initial access, the WTRU may apply cluster assistance information acquired via broadcast signaling (e.g., for initial access) and upon completion of the Random Access procedure receive (e.g., via RRC Setup complete or RRC Resume message) dedicated cluster assistance information.

In one embodiment, upon WTRU transition to an RRC Idle or RRC Inactive state, the WTRU may release dedicated cluster assistance information. Alternatively, the WTRU may be provided with updated cluster assistance information in a release message (e.g., RRC Release, or RRC Release with suspend config).

Cluster assistance information may include coordinates of the cluster center(s) (e.g., Assisted Global Navigation Satellite System (A-GNSS) coordinates of the cluster center).

Cluster assistance information may include assistance information for determination of cluster coverage, for example: ellipsoid points, diameter or radius of cluster.

Cluster assistance information may include coordinates of neighboring cluster center(s) and assistance information of neighboring cluster coverage (e.g., ellipsoid points, diameter or radius of neighboring cluster).

Cluster assistance information may include assistance information to associate a cluster with a network identifier. For example, each cluster may be associated with a PLMN ID, cell ID, satellite, gNB, or AMF.

Cluster assistance information may include a flag indicating whether one cluster overlaps with a second cluster with a different network identifier. For example, the WTRU may be notified that a cluster overlaps with another cluster from a different PLMN, cell, satellite, or other network identifier.

Cluster assistance information may include a range of valid WTRU-specific timing advance. For example, a cluster may be associated with a minimum and/or maximum WTRU-specific timing advance value. The WTRU may, for example, only consider associating with a cluster if the WTRU-specific timing advance calculation of the WTRU falls within the range and/or min/max thresholds.

Cluster assistance information may include a range of valid GNSS coordinates. For example, a cluster may be associated with a minimum and/or maximum GNSS coordinate. The WTRU may, for example, only consider associating with a cluster if the GNSS measurements of the WTRU fall within the range and/or min/max thresholds.

Cluster assistance information may include one or more preambles associated with a cluster.

The validity of cluster assistance information may be semi-static (i.e., the WTRU may consider the cluster assistance information as valid until otherwise indicated) or may be subject to expiry. The network may explicitly indicate whether cluster assistance information is considered semi-statically valid, or the WTRU may determine implicitly based on, for example, the network deployment scenario. For example, the WTRU may consider clusters associated with geo-stationary (GEO) or geo-synchronous (GSO) satellite deployment as semi-static, and those with non-geostationary (e.g., non-geostationary orbit (NGSO), Low Earth Orbit (LEO), Medium Earth Orbit (MEO)) as subject to expiry.

The network may explicitly indicate whether cluster assistance information is considered semi-statically valid, or the WTRU may determine implicitly based on, for example, the presence of a validity duration or timer. For example, if the cluster assistance information is associated with a validity timer, then the WTRU may assume that it is no longer valid upon timer expiry. Alternatively, the assistance information may be described by an expiry time (e.g., UTC time), or subject to a counter.

Upon expiry of cluster assistance information validity, the WTRU may, for example, perform one or more of the following actions: re-acquire system information; request updated cluster information; perform an RRC state transition (e.g., perform random access, or transition to RRC idle/inactive); and/or send a scheduling request.

### Selection of Clusters in Non-Terrestrial Networks

A WTRU may select a cluster subject to satisfaction of one or more conditions associated with a cluster. For example, the WTRU may select a cluster that satisfies one or more of the following conditions: 1) the acquired A-GNSS position of the WTRU falls within the coverage of the cluster; 2) the WTRU-estimated WTRU-specific Timing Advance (TA) falls within a range associated with a cluster (e.g., a range of a cluster may be defined by the center point of the cluster and a diameter of the cluster, if the cluster is a circle); 3) the acquired GNSS position falls within a range associated with a cluster; 4) the cluster is associated with a specific network identifier. For example, the WTRU may only select clusters associated with a specific PLMN ID, satellite, gNB, Cell ID, or AMF; and/or 5) The center of the cluster falls within a distance from the WTRU GNSS position. This distance may be, e.g., configured or provided in system information.

### Report of Cluster Selection During Initial Access/Random Access

The WTRU may report its selected cluster during initial access (or, more generally, during the Random Access procedure). Whether the WTRU reports a selected cluster during initial access may be subject to network configuration. For example, the network may broadcast (e.g., via system information) an indication whether cluster reporting is enabled or disabled.

In one embodiment, the WTRU may report its selected cluster, for example, via transmission of a dedicated preamble associated with the cluster.

In another embodiment, the WTRU may report its selected cluster, for example, via a Cluster Report MAC CE. This MAC CE may be included, for example, in a Msg3, Msg5, or MsgA PUSCH resource. The structure of the Cluster Report MAC CE may have fixed or variable size, and may be defined by, for example, one or more of: one or more selected cluster(s); information linking the cluster to a network identity (e.g., PLMN ID, cell ID, satellite, gNB, or AMF); the WTRU ID; and/or one or more reserved bits.

How the WTRU reports the selected cluster may be subject to network configuration. For example, the network may provide, via system information, an indication containing the method of transmission (e.g., via an associated preamble, in a Msg3, Msg5, or MsgA PUSCH resource).

In another solution, the WTRU may implicitly select which message to include the Cluster Report MAC CE in via the grant size provided. For example, the WTRU may include the Cluster Report MAC CE in Msg3 or MsgA subject to an UL grant size sufficiently large to include the Cluster Report MAC CE. Should the WTRU grant not be of sufficient size, the WTRU may instead include the Cluster Report MAC CE in a subsequent UL grant.

In another solution, the WTRU may be configured to jointly report the selected cluster with another piece of information. For example, the WTRU may report the selected cluster in the same message as the WTRU-specific TA report.

The WTRU may alternatively report one or more additional clusters other than that of the selected cluster. For example, the WTRU may report all clusters with center coordinates that fall within a configured distance threshold from the WTRU.

### 4.7 Details of Cluster-Based PRS Configuration

### Cluster-Specific and Common PRS Configurations

The WTRU may determine that the PRS configuration or the aforementioned PRS parameters (e.g., PRS bandwidth, number of PRS resource sets) depend on cluster information (e.g., size, density, location of the cluster). For example, the WTRU may be preconfigured with an association between size of a cluster and the number of TRPs (e.g., 5 TRPs associated with a cluster with a diameter 1 kilometer, 10 TRPs associated with a cluster with a diameter 5 kilometer) or density of a cluster (e.g., 5 PRS resources for a cluster with 10 WTRUs/1 square kilometer). The WTRU may determine that PRS bandwidth allocated for PRS is dependent on cluster size based on a pre-configuration received from the network.

In another example, the WTRU may determine that PRS configuration associated with a cluster depends on features of the cluster (e.g., cluster ID). For example, PRS resource sequences associated with a cluster may be scrambled by cluster ID such that PRS sequences used in neighboring clusters do not cause interference between each other.

In another example the WTRU may determine PRS configurations based on whether the clusters are overlapping with other clusters. For example, the WTRU may determine that the cluster ID of the associated cell is used to scramble PRS sequences, if the WTRU is associated with a cell that is overlapping with another cell.

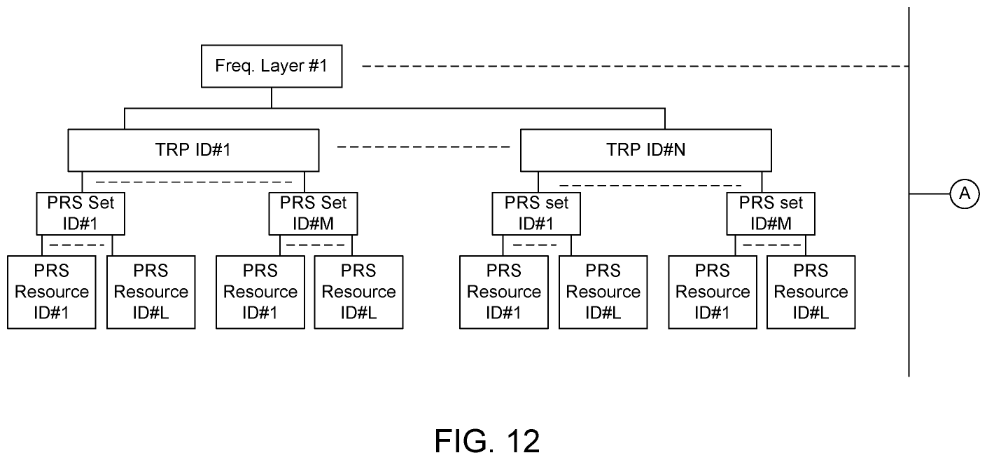

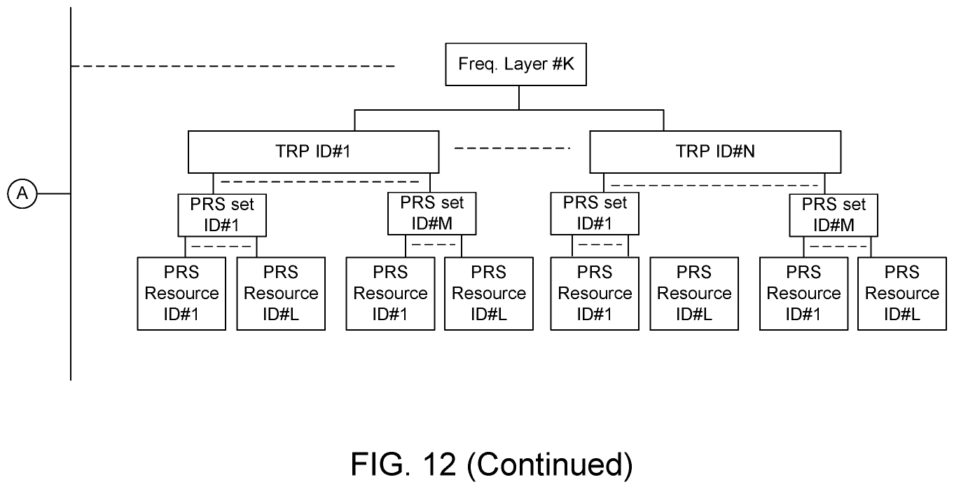

The WTRU may determine common PRS parameters and cluster-specific PRS parameters from the configuration received from the network. For example, according to the hierarchical structure illustrated in FIG. 12, the WTRU may determine that the common frequency layer configurations (e.g., the same value of ARFCN for Frequency Layer #1 for all clusters in a cell) are to be used for all clusters in a cell. The WTRU may obtain the common parameters from the network less frequently via broadcast or dedicated signaling for the WTRU. In another example, the WTRU may send a request to the network to obtain the common PRS parameters.

In another example, the WTRU may determine that some parameters in the PRS configuration hierarchy are specific to clusters. For example, the PRS resource configurations may be specific to each cluster where the random number generator used to generate a PRS sequence may be initialized by cluster ID or the PRS sequence is scrambled by cluster ID.

The number of PRS resources in a PRS resource set may be cluster-specific. For example, the WTRU may determine that the number of PRS resources in a PRS resource set depends on the size of a cluster or density of a cluster (e.g., number of WTRUs in a cluster).

The WTRU may obtain cluster-specific PRS parameters via broadcast or WTRU-dedicated message. For example, once the WTRU determines which cluster the WTRU is associated with, the WTRU may send a request to the network for cluster-specific parameters (e.g., configurations related to PRS resource sets, TRPs). The WTRU may obtain cluster-specific information via broadcast.

### Cluster Information During IDLE/INACTIVE Mode

In one example, the WTRU may determine to send a request for cluster information during IDLE mode depending on at least one associated RRM measurement. For example, if RSRP of SSBs from serving/neighboring cells are below a threshold, the WTRU may determine to send a request (e.g., RRC system info request) to the network to broadcast cluster information and/or to transfer cluster information in a dedicated message (e.g., LPP). After the WTRU establishes RRC connection with network and operates in RRC_CONNECTED state, the WTRU may determine whether to associate itself with a cluster based on the Radio Resource Management (RRM) related measurements and/or the cluster information that may be received by the WTRU in a broadcast message (e.g., in positioning SIB) or dedicated message (e.g., in LPP). When receiving the cluster information via broadcast message, the WTRU may use the same configured periodicity applied for monitoring and receiving any SIB and/or positioning SIB. Alternatively, the WTRU may switch to using another periodicity, possibly configured/indicated by the network to the WTRU, for monitoring and receiving the cluster information. In this case, the periodicity applied by the WTRU for receiving the cluster information in SIB may vary depending on parameters associated with the cluster (e.g., cluster dimensions, number of WTRUs in the cluster, etc.) and/or the type of request sent by the WTRU (e.g., RACH preamble applied, flag indicated by WTRU in request), for example. Alternatively, the WTRU may receive an indication of the latest time for which the cluster information may be valid. The WTRU may trigger a system information request before or at this time to receive up to date cluster information.

In another example, the WTRU may send a request for cluster information to the network in msg3. The WTRU may determine which cluster the WTRU should be associated with after the WTRU receives msg4, containing cluster information, from the network. For example, when the WTRU operates in INACTIVE state, the WTRU may send the request for cluster information in a Small Data Transmission (SDT) message (e.g., RRC message in any of the SDT-SRBs, UL MAC CE in any of the SDT-DRBs) using RACH-SDT or Configured Grant (CG)-SDT resources. The WTRU may receive from the network cluster information in an RRC RELEASE message, for example, in a manner similar to the 2-step resume procedure for RAN area update. The WTRU may obtain cluster information in suspend configuration in the release message. In another example, the WTRU may receive the cluster information from the network in a DL-SDT message (e.g., RRC message or DL MAC CE).

### 4.8 Differential Cluster-Based Reporting

### Differential Positioning Calculation

In one embodiment, a WTRU may determine to send differential location information to the network in a positioning report when the UE determines to activate cluster-based positioning, wherein the reference location is determined by the initial PRS configuration and differential locations are determined by PRS configurations associated with clusters.

A differential report, containing a reference location and differential locations, may be beneficial due to the smaller range needed to express a differential location, i.e., fewer bits needed to express the location as a differential location rather than a full location. In addition, since cluster-based positioning may use PRS configurations associated with more than one cluster, reporting of location per cluster may be needed for some applications. In that case, to indicate association among the locations to the reference location (e.g., a location estimate determined based on the initial PRS configuration) derived based on different cluster-based PRS configurations, the WTRU may include both reference and differential locations in the report and send it to the network.

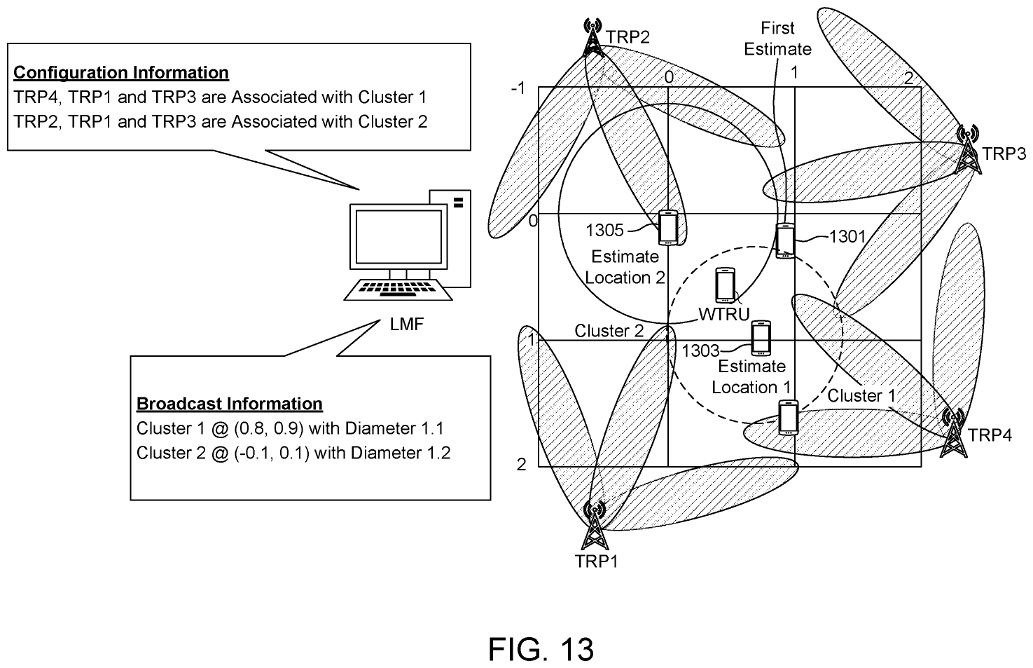

FIG. 13 is a diagram illustrating one such embodiment wherein the WTRU receives cluster information and PRS configurations associated with clusters from the network. Particularly, the WTRU may receive the initial/default PRS configuration from the network (e.g., from the LMF or gNB) and determines to perform WTRU-based positioning based on that configuration/indication. The WTRU determines the first estimated position 1301 (i.e., the “reference” location) based on the initial/default PRS configuration. Then, based on the PRS configuration associated with cluster 1, the WTRU determines its position, “estimate location 1” 1303. Next, based on the PRS configuration associated with cluster 2, the WTRU determines its position, “estimate location 2” 1305. The WTRU reports location information to the network. In the report the WTRU includes differential positioning information relative to the reference location, such as described in more detail below.

### An Example of Non-Differential Positioning Calculation

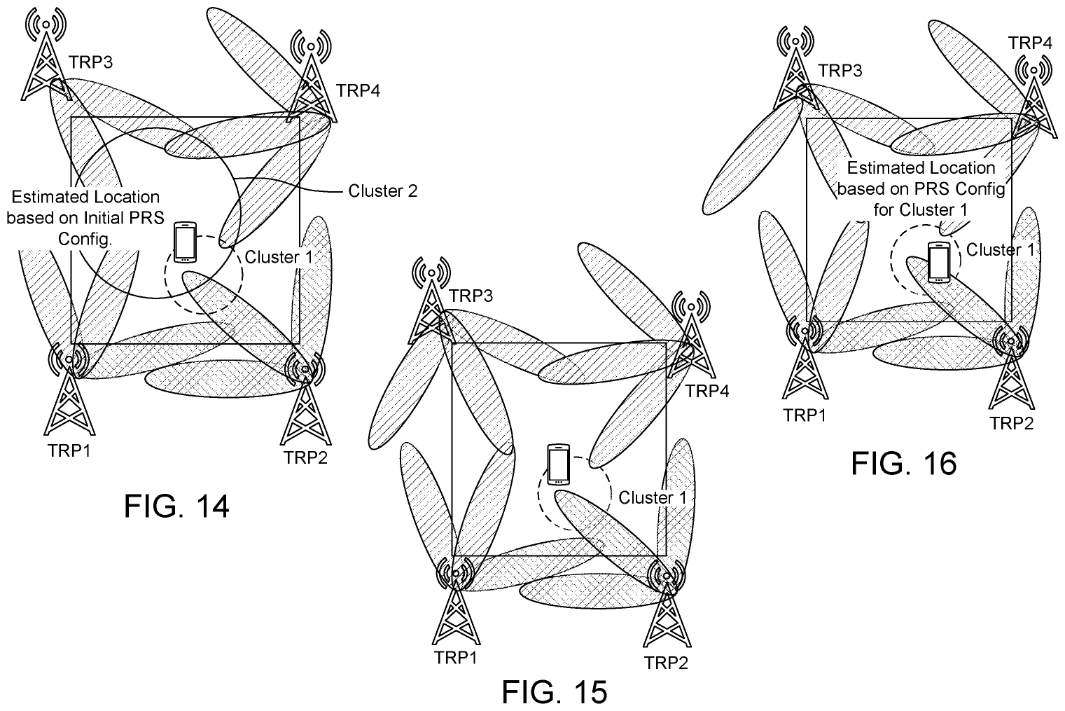

An exemplary embodiment is illustrated through FIGS. 14, 15, and 16. In FIG. 14, the WTRU receives configurations for two clusters, cluster 1 and cluster 2. The WTRU also receives the initial PRS configuration. Based on the initial PRS configuration, the WTRU determines its position. Since its position is encompassed by two clusters, the WTRU determines which of the two clusters to associate itself with.

In an exemplary embodiment, the WTRU may be configured to select the cluster of the smallest size. In such an embodiment, since the size (e.g., diameter) of cluster 1 is smaller than that of cluster 2, the WTRU determines to associate itself with cluster 2 as shown in FIG. 15. The WTRU sends a request to the network (e.g., LMF, gNB) for the PRS configuration associated with cluster 1.

After the WTRU receives the PRS configuration associated with cluster 1 (e.g., PRS resources transmitted from TRP2, a subset of PRS resources transmitted from TRP1), the WTRU determines its position based on the PRS configuration associated with cluster 1, as illustrated by FIG. 16.

In one example, cluster 1 and cluster 2 may be referred to as potential clusters. Potential clusters may be configured by the network as pre-configuration. The cluster(s) the WTRU determined to associate itself with may be referred to as actual cluster(s). The actual clusters may be a subset of potential clusters.

### Differential Location Reporting

In differential reporting, the WTRU indicates the reference location (initial/default PRS configuration, e.g., 1301 in FIG. 13) and differential locations which are determined based on the difference between the reference location and locations determined based on PRS configurations associated with clusters.

For example, in differential reporting, the first estimate is used as the reference and “Estimate location 1” and “Estimate location 2” are expressed as differentials from the reference point. For example, if coordinates of the first estimate 1301, “Estimate location 1” 1303, and “Estimate location 2” 1305 are (−1,1), (5,1) and (2,4), respectively, the report will contain (−1,1), (6,0) and (3,3), where the latter two locations are expressed by computing the difference between the locations derived from PRS configurations associated with those two clusters relative to the reference location.

The WTRU may be configured with a reference location by the network (e.g., an absolute position of a reference point).

The WTRU determines to use the location based on a preconfigured/default/initial PRS configuration.

If the WTRU is not configured with the default/initial PRS configuration by the network, the WTRU may determine to indicate a reference point in the differential report.

The WTRU also may indicate in the report whether the WTRU determined the reference point or the reference point is derived based on preconfigured PRS configuration. For example, the WTRU may indicate an ID of an entity (e.g., PRU, TRP, RSU (Road Side Unit)) whose location is used as the reference point.

The WTRU may associate cluster ID/PRS configurations (e.g., TRP ID, PRS resource ID, PRS resource set ID) with differential locations, where the differential location is determined based on the associated PRS configuration.

The WTRU may receive PRS configurations with potential clusters from the network. The WTRU may determine its position based on the initial PRS configuration. Based on the initial PRS configuration, the WTRU may determine which cluster(s) the WTRU is associated with, thus determining actual cluster(s). Based on the actual clusters the WTRU associates itself with, the WTRU may determine PRS configurations to use to determine differential locations. The WTRU may determine the PRS configurations based on the preconfigured PRS configurations associated with clusters.

### Enabling Differential Reporting

The WTRU may determine to send a differential location report to the network when cluster-based positioning is enabled/configured/activated by the WTRU or network. The WTRU may determine to enable/activate cluster-based positioning when the WTRU receives cluster information from the network.

The WTRU may determine to disable/deactivate cluster-based positioning when the WTRU does not receive cluster information from the network.

at least one of the following conditions is satisfied:

The WTRU may determine to disable/deactivate cluster-based positioning when the location of the WTRU is not included/encompassed in any of the clusters identified by the network.

The WTRU may determine to disable/deactivate cluster-based positioning when the WTRU receives an indication to deactivate/stop cluster-based positioning from the network.

The WTRU may determine to disable/deactivate cluster-based positioning when a timer/time window (e.g., expressed in terms of slots/symbols/frames) for cluster-based positioning expires.

The WTRU may determine to disable/deactivate cluster-based positioning based on any combination of the above factors.

### Details Related to a Cluster

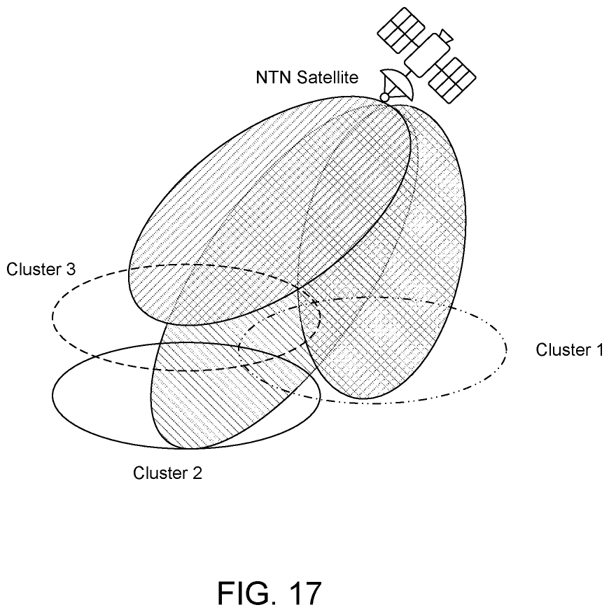

In one example, a cluster may be contained within a cell. A cell may contain more than one clusters. Multiple clusters may overlap and share overlapped area(s). A cluster may be created based on beam coverage from a TRP/satellite. An illustrative example is shown in FIG. 17. For example, each beam transmitted from an NTN satellite may correspond to a cluster. Each cluster (e.g., cluster 1, 2 and 3 in FIG. 17) may be associated with a PRS configuration. More than one cluster (e.g., cluster 1 and 2) may be associated with the same PRS configuration.

In one example, a cluster may be associated with a cluster ID. Cluster IDs may be associated with a cell ID if there are multiple clusters in a cell.

The WTRU may receive information related to clusters (e.g., cluster size, location of clusters) from the network by broadcast/groupcast/unicast. The WTRU may receive information related to clusters by broadcast and/or dedicated signaling (e.g., via RRC, LPP, MAC-CE, DCI). In one example, the center of a cluster may be indicated by a reference point/entity (e.g., PRU, RSU, TRP, a reference WTRU). For example, the network may indicate the center of the cluster by the location of a reference point/entity.

In one example, a PRS configuration may be associated with one cluster. In another example, a PRS configuration may be associated with more than one cluster.

In one embodiment, the WTRU is configured with WTRU-based DL positioning. The WTRU receives the first PRS configuration. The WTRU receives locations and size of clusters (e.g., center, diameter, cluster ID) and associated PRS configuration (e.g., TRPs associated with each cluster) from the network. The WTRU determines its location (e.g., first location) using the first PRS configuration. Based on the first location, the WTRU determines the cluster which encompasses the first location and associated PRS configuration (second PRS config). The WTRU may determine its location based on the second PRS configuration and reports it to the network. If the determined WTRU location is encompassed by more than one cluster, the WTRU determines a set of WTRU locations based on PRS config associated with each such cluster. For example, using the first location as the reference location, the WTRU may determine relative location for each WTRU location in the set with respect to the reference location. In some cases, the WTRU reports the reference location(s) and relative location(s) along with the corresponding cluster ID.

### 5 CONCLUSION

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, MME, EPC, AMF, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

The WTRU may be used in conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

Although the various embodiments have been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although the invention is illustrated and described herein with reference to specific embodiments, the invention is not intended to be limited to the details shown. Rather, various modifications may be made in the details within the scope and range of equivalents of the claims and without departing from the invention.

1-28. (canceled)

29. A method implemented in a wireless transmit/receive unit (WTRU), the method comprising:
receiving one or more indications that indicate:
a first position reference signal (PRS) configuration,
a second PRS configuration, a first cluster associated with the second PRS configuration, and first cluster information associated with the first cluster, and
a third PRS configuration, a second cluster associated with the third PRS configuration, and second cluster information associated with the second cluster;
determining a first location of the WTRU using the first PRS configuration;
selecting a cluster from the first and second clusters, wherein the selection of the cluster is based at least on the first location and one or more of the first cluster information or the second cluster information, wherein the selected cluster encompasses the first location, and wherein the selected cluster is the first cluster associated with the second PRS configuration;
determining, based on the second PRS configuration associated with the selected cluster, a second location of the WTRU; and
sending information that indicates the second location of the WTRU and the selected cluster.

30. The method of claim 29, wherein the first cluster and the second cluster are defined by a respective central location and a respective diameter.

31. The method of claim 29, wherein the first cluster information and the second cluster information comprise respective cluster identification and/or respective cluster location information.

32. The method of claim 29, wherein the first and second clusters encompass the first location.

33. The method of claim 29, wherein the first cluster is smaller than the second cluster.

34. The method of claim 29, wherein the selection of the cluster is further based on the first cluster being smaller than the second cluster.

35. The method of claim 29, wherein the second location is a relative position to the WTRU.

36. The method of claim 35, wherein the relative position of the second location is based on the first PRS configuration.

37. A wireless transmit/receive unit (WTRU) comprising:
a processor configured to at least:
receive one or more indications that indicate:
a first position reference signal (PRS) configuration,
a second PRS configuration, a first cluster associated with the second PRS configuration, and first cluster information associated with the first cluster, and
a third PRS configuration, a second cluster associated with the third PRS configuration, and second cluster information associated with the second cluster;
determine a first location of the WTRU using the first PRS configuration;
select a cluster from the first and second clusters, wherein the selection of the cluster is based at least on the first location and one or more of the first cluster information or the second cluster information, wherein the selected cluster encompasses the first location, and wherein the selected cluster is the first cluster associated with the second PRS configuration;
determine, based on the second PRS configuration associated with the selected cluster, a second location of the WTRU; and
send information that indicates the second location of the WTRU and the selected cluster.

38. The WTRU of claim 37, wherein the first cluster and the second cluster are defined by a respective central location and a respective diameter.

39. The WTRU of claim 37, wherein the first cluster information and the second cluster information comprise respective cluster identification and/or respective cluster location information.

40. The WTRU of claim 37, wherein the first and second clusters encompass the first location.

41. The WTRU of claim 37, wherein the first cluster is smaller than the second cluster.

42. The WTRU of claim 37, wherein the selection of the cluster is further based on the first cluster being smaller than the second cluster.

43. The WTRU of claim 37, wherein the second location is a relative position to the WTRU.

44. The WTRU of claim 43, wherein the relative position of the second location is based on the first PRS configuration.
